(19) United States
(12) Patent Application Publication
(10) Pub. No.: US 2026/0303260 A1
(43) Pub. Date: Oct. 1, 2026

(54) ENHANCED CODED MODULATION FOR WIRELESS COMMUNICATIONS

(71) Applicant: Lenovo (United States) Inc., Morrisville, NC (US)

(72) Inventors: Abir Ben Hadj Fredj, Wiesbaden (DE); Razvan-Andrei Stoica, Essen (DE); Karthikeyan Ganesan, Nauheim (DE); Ali Ramadan Ali, Kraiburg (DE)

(73) Assignee: Lenovo (United States) Inc., Morrisville, NC (US)

(21) Appl. No.: 19/097,617

(22) Filed: Apr. 1, 2025

(51) Int. Cl. H04L 1/00; H04L 27/26; H04L 27/34

(52) U.S. Cl. CPC H04L 1/0061; H04L 27/26025; H04L 27/34

(57) ABSTRACT

Various aspects of the present disclosure relate to enhanced coded modulation for wireless communications. One or more codewords may be obtained based at least in part on encoding data using FEC encoding. The one or more codewords may be mapped to one or more sequence codes. Each sequence code may be associated with a plurality of coset representatives capable of representing a coset corresponding to a subset of QAM symbols of a QAM constellation. The one or more sequence codes may be mapped to one or more QAM symbols, to obtain the one or more QAM symbols.

### TECHNICAL FIELD

The present disclosure relates to wireless communications, and more specifically to enhanced coded modulation for wireless communications.

### BACKGROUND

A wireless communications system may include one or multiple network communication devices, which may be otherwise known as network equipment (NE) or other suitable terminology, supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The International Mobile Telecommunications (IMT)-2030 Framework, developed by the International Telecommunication Union (ITU), identifies various capabilities for wireless communications beyond 5G. One of the capabilities relate to spectrum efficiency.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

In a first aspect, some implementations of the methods, systems, and apparatuses described herein may be performed or implemented by an apparatus for wireless communications. The apparatus may be a user equipment (UE) or a network equipment (NE). For example, some implementations of the methods, systems, and apparatuses in the first aspect may be performed or implemented by a transmitter chain of an apparatus for wireless communications.

Some implementations of the methods, systems, and apparatuses described herein may include, in the first aspect: obtaining one or more codewords based at least in part on encoding data using forward error correction (FEC) encoding, mapping the one or more codewords to one or more sequence codes, mapping the one or more sequence codes to one or more quadrature amplitude modulation (QAM) symbols, and obtaining the QAM symbols. The mapping of the one or more codewords to the one or more sequence codes may be arranged such that each of the one or more sequence codes may be associated with a plurality of coset representatives capable of representing a coset corresponding to a subset of QAM symbols of a QAM constellation. The data may include information bits.

In some implementations of the methods, systems, and apparatuses described herein, in the first aspect, the mapping of the one or more codewords to the one or more sequence codes may be based at least in part on the QAM symbols of the QAM constellation partitioned into a plurality of disjoint subsets each corresponding to a respective coset representable by coset representatives, and a quantity of disjoint subsets may be associated with at least one of a modulation order M of the QAM constellation or a sequence coding gain associated with the mapping of the one or more codewords to the one or more sequence codes.

In some implementations of the methods, systems, and apparatuses described herein, in the first aspect, the one or more codewords comprise serially-concatenated codewords. Some implementations of the methods, systems, and apparatuses described herein may include, in the first aspect, perform a serial-to-parallel conversion to convert the serially-concatenated codewords into a plurality of parallel codewords, prior to mapping the one or more codewords to one or more sequence codes.

In some implementations of the methods, systems, and apparatuses described herein, in the first aspect, mapping the one or more codewords to the one or more sequence codes based at least in part on a mapping function. The mapping function may be represented by bᵢ→xₗ= [symbol] . bᵢ, where bᵢ is the i^{th} codeword, xₗ is the l^{th} sequence code which comprises a bit sequence associated with corresponding coset representatives, and [symbol] is a coset generator matrix corresponding to the j^{th} coset [symbol] .

In some implementations of the methods, systems, and apparatuses described herein, in the first aspect, a minimum squared Euclidean distance (MSED) associated with any two sequence codes may be larger than a MSED associated with any two QAM symbols.

Some implementations of the methods, systems, and apparatuses described herein may include, in the first aspect, obtaining a set partitioning of the QAM constellation, and mapping the one or more codewords to one or more sequence codes based at least in part on the set partitioning of the QAM constellation.

In some implementations of the methods, systems, and apparatuses described herein, in the first aspect, the set partitioning of the QAM constellation comprises the QAM constellation partitioned into a plurality of disjoint subsets each corresponding to a respective coset representable by a plurality of coset representatives, and the partitioning may be such that a MSED is maximized (e.g., doubled) for a transition from a higher partition level to a lower partition level. In some implementations of the methods, systems, and apparatuses described herein, in the first aspect, the coset representatives may be selected at each of the partition levels.

In some implementations of the methods, systems, and apparatuses described herein, in the first aspect, the obtaining of the set partitioning of the QAM constellation is based at least in part on: a modulation order M of the QAM constellation, a code rate, or both.

In some implementations of the methods, systems, and apparatuses described herein, in the first aspect, the obtaining of the set partitioning of the QAM constellation is based at least in part on a modulation order M of the QAM constellation matching or exceeding a reference modulation order O. For example, the reference modulation order may be O=2^{P}, where P may be an integer equal to 9.

In some implementations of the methods, systems, and apparatuses described herein, in the first aspect, the modulation order M of the QAM constellation may be 2^{N}, where N may be an integer greater than or equal to 10.

In a second aspect, some implementations of the methods, systems, and apparatuses described herein may be performed or implemented by an apparatus for wireless communications. The apparatus may be a UE or a NE. For example, some implementations of the methods, systems, and apparatuses in the second aspect may be performed or implemented by a receiver chain of an apparatus for wireless communications.

Some implementations of the methods, systems, and apparatuses described herein may include, in the second aspect: obtaining one or more QAM symbols, mapping the one or more QAM symbols to one or more sequence codes, mapping the one or more sequence codes to one or more codewords, and obtaining data based at least in part on decoding the one or more codewords using FEC decoding. Each of the one or more sequence codes may be associated with a plurality of coset representatives capable of representing a coset corresponding to a subset of QAM symbols of a QAM constellation. The obtained data may include information bits. Obtaining the one or more QAM symbols may include detecting or demodulating the one or more QAM symbols.

Some implementations of the methods, systems, and apparatuses described herein may include, in the second aspect, mapping the one or more sequence codes to the one or more codewords based at least in part on a mapping function. The mapping function may be represented by:

$${x}_{l} \to {b}_{i} = {G}_{{𝒞}_{j}}^{- 1} \cdot {x}_{l} ,$$

where xₗ is the l^{th} sequence code which comprises a bit sequence associated with a corresponding coset representative, bᵢ is the i^{th} codeword, and

$${G}_{{𝒞}_{j}}^{- 1}$$

is an inverse of a coset generator matrix corresponding to the j^{th} coset [symbol] .

In some implementations of the methods, systems, and apparatuses described herein, in the second aspect, a modulation order M of the QAM constellation may be=2^{N} and N may be an integer greater than or equal to 10.

In a third aspect, some implementations of the methods, systems, and apparatuses described herein may be performed or implemented by a transmitter chain for wireless communications. The transmitter chain may be arranged in an apparatus for wireless communications. The apparatus may be a user equipment (UE) or a network equipment (NE).

Some implementations of the methods, systems, and apparatuses described herein include, in the third aspect, encoding data into one or more codewords, mapping the one or more codewords to one or more sequence codes, and mapping the one or more sequence codes to one or more QAM symbols. The mapping of the one or more codewords to one or more sequence codes may be arranged such that each of the one or more sequence codes may be associated with a plurality of coset representatives capable of representing coset corresponding to a subset of QAM symbols of a QAM constellation. For example, the encoding of the data may be performed by a FEC encoder of a transmitter chain. For example, the mapping of the one or more codewords to the one or more sequence codes may be performed by a sequence code encoder of a transmitter chain. For example, the mapping the one or more sequence codes to one or more QAM symbols may be performed by a QAM modulator (or mapper) of a transmitter chain.

In some implementations of the methods, systems, and apparatuses described herein, in the third aspect, the one or more codewords may comprise serially-concatenated codewords. Some implementations of the methods, systems, and apparatuses described herein may include, in the third aspect, performing a serial-to-parallel conversion to convert the serially-concatenated codewords into a plurality of parallel codewords. For example, the converting may be performed by a serial-to-parallel converter of a transmitter chain. The serial-to-parallel converter may be operably coupled between the FEC encoder and the sequence code encoder.

In a fourth aspect, some implementations of the methods, systems, and apparatuses described herein may be performed or implemented by a receiver chain for wireless communications. The receiver chain may be arranged in an apparatus for wireless communications. The apparatus may be a user equipment (UE) or a network equipment (NE).

Some implementations of the methods, systems, and apparatuses described herein include, in the fourth aspect, obtaining one or more QAM symbols, mapping the one or more QAM symbols to one or more sequence codes, mapping the one or more sequence codes to one or more codewords, and decoding the one or more codewords to obtain data. Each of the one or more sequence code may be associated with a plurality of coset representatives capable of representing a coset corresponding to a subset of QAM symbols of a QAM constellation. Obtaining the one or more QAM symbols may include detecting or demodulating the one or more QAM symbols. For example, the obtaining and mapping of the one or more QAM symbols may be performed by a QAM demodulator of a receiver chain. For example, the mapping of the one or more sequence codes to one or more codewords may be performed by a sequence code decoder of a receiver chain. For example, the decoding of the one or more codewords may be performed by a FEC decoder of a receiver chain.

### BRIEF DESCRIPTION OF THE DRAWINGS

FIG. 1 illustrates an example of a wireless communications system in accordance with aspects of the present disclosure.

FIG. 2 illustrates an example of a coset code encoder in accordance with aspects of the present disclosure.

FIG. 3 illustrates an example of Trellis coded modulation (TCM) in accordance with aspects of the present disclosure.

FIG. 4A illustrates an example of TCM in accordance with aspects of the present disclosure.

FIG. 4B illustrates an example of TCM in accordance with aspects of the present disclosure.

FIG. 4C illustrates an example of TCM in accordance with aspects of the present disclosure.

FIG. 5 illustrates an example of set partitioning of an 8-phase shift keying (8PSK) constellation in accordance with aspects of the present disclosure.

FIG. 6 illustrates examples of minimum squared Euclidean distance (MSED) of sequence coding in accordance with aspects of the present disclosure.

FIG. 7 illustrates an example of a transmitter chain in accordance with aspects of the present disclosure.

FIG. 8 illustrates an example of a 64-QAM as a union of 4 disjoint cosets in accordance with aspects of the present disclosure.

FIG. 9 illustrates an example of a receiver chain in accordance with aspects of the present disclosure.

FIG. 10 illustrates an example of set partitioning of a 16-QAM constellation in accordance with aspects of the present disclosure.

FIG. 11 illustrates an example of a UE in accordance with aspects of the present disclosure.

FIG. 12 illustrates an example of a processor in accordance with aspects of the present disclosure.

FIG. 13 illustrates an example of a NE in accordance with aspects of the present disclosure.

FIG. 14 illustrates a flowchart of a method in accordance with aspects of the present disclosure.

FIG. 15 illustrates a flowchart of a method in accordance with aspects of the present disclosure.

### DETAILED DESCRIPTION

Channel coding and modulation schemes are core building blocks in wireless communications systems. Conventional coherent transmission based on QAM uses a combination of phase and amplitude to encode data bits. In QAM, each constellation point corresponds to a unique combination of phase and amplitude, with the phase being represented by the angle and the amplitude being represented by the distance from the center of the QAM constellation diagram. High order modulation schemes such as super QAM (e.g., 1024-QAM or 4096-QAM) may present a way for increasing spectral efficiency. However, for super QAM or like higher order modulation schemes, the MSED of the constellation may be reduced (when compared with lower order modulation schemes) and this may undesirably affect the symbol detection and decoding performance, especially in fading channels.

One option to mitigate such reduced MSED of super QAM or the impacts of fading channels on the received signal, or to improve accuracy of detection of the symbols at the receiver, may be to apply bit-to-symbol mapping.

Implementations disclosed herein provide various solutions related to enhanced coded modulation for wireless communications. Specifically, implementations disclosed herein provide techniques that can enable the enhancement of detection of symbols at the receiver based on sequence coding and lattice set partitioning of the QAM constellation. Sequence coding gain may be enabled through the increase of the MSED between the sequences compared with the MSED of the constellation symbols. This may be enabled by selection of sequences based on set partitioning and the choice of sequences at each partition level such that the MSED is doubled or maximized when transiting from one level to the other.

Implementations disclosed herein provide various techniques for enhanced coded modulation using lattice partitions and coset codes for the bit-labeling of FEC (e.g., low-density parity-check (LDPC)) encoded bits (i.e., codewords). A mapping function may be applied to map the encoded FEC bits (codewords) into coset representatives constructed using lattice partitioning techniques. The mapping function may map the encoded FEC bits into one or more coset representatives chosen from different cosets or lattice partitions to enhance the symbol detection capability at the receiver. At the receiving side, the stream of bits received at the receiver may be jointly detected and decoded. In some cases, in addition to coset mapping, set partitioning may be used to enable larger Euclidean distance between sequences to improve resilience against errors even when a higher order modulation is used and for different channel conditions (e.g., fading channels).

Aspects of the present disclosure are described in the context of a wireless communications system. The wireless communications system is configured to support enhanced coded modulation for wireless communications.

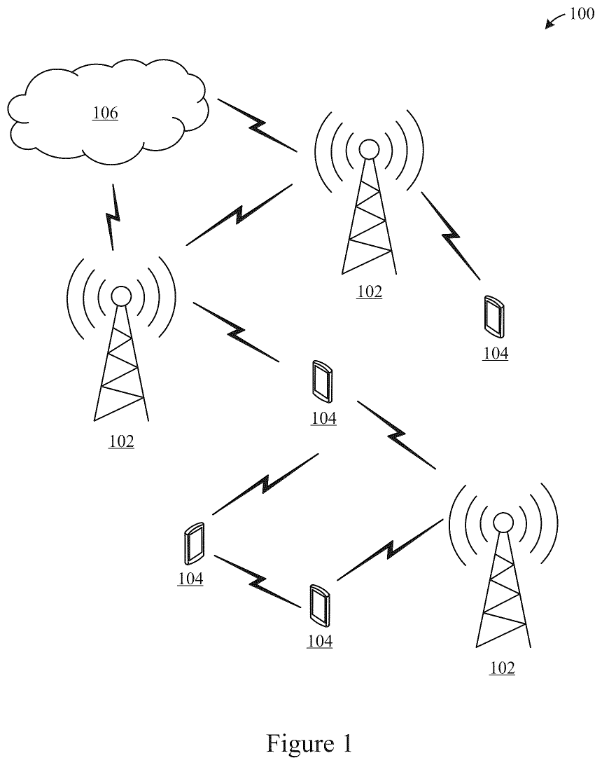

FIG. 1 illustrates an example of a wireless communications system 100 in accordance with aspects of the present disclosure. The wireless communications system 100 may be configured to support enhanced coded modulation for wireless communications. The wireless communications system 100 may include one or more NE 102, one or more UE 104, and a core network (CN) 106. The wireless communications system 100 may support various radio access technologies. In some implementations, the wireless communications system 100 may be a 4G network, such as a long-term evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communications (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communications of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communications directly with other UEs 104 over a communication link. For example, a UE 104 may support wireless communications directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communications directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The UE 102 may be configured to support enhanced coded modulation for wireless communications. In some implementations, the UE 102 may be configured to transmit data. For example, the UE 102 may be configured to obtain one or more codewords based at least in part on encoding data using FEC encoding, map the one or more codewords to one or more sequence codes, map the one or more sequence codes to one or more QAM symbols, and obtain the one or more QAM symbols. Each sequence code may be associated with coset representatives capable of representing a coset corresponding to a subset of QAM symbols of a QAM constellation. In some implementations, the UE 102 may be configured to receive data. For example, the UE 102 may be configured to obtain one or more QAM symbols, map the one or more QAM symbols to one or more sequence codes, map the one or more sequence codes to one or more codewords, and obtain data based at least in part on decoding the one or more codewords using FEC decoding. Each sequence code may be associated with coset representatives capable of representing a coset corresponding to a subset of QAM symbols of a QAM constellation.

The NE 104 may be configured to support enhanced coded modulation for wireless communications. In some implementations, the NE 104 may be configured to transmit data. For example, the NE 104 may be configured to obtain one or more codewords based at least in part on encoding data using FEC encoding, map the one or more codewords to one or more sequence codes, map the one or more sequence codes to one or more QAM symbols, and obtain the one or more QAM symbols. Each sequence code may be associated with coset representatives capable of representing a coset corresponding to a subset of QAM symbols of a QAM constellation. In some implementations, the NE 104 may be configured to receive data. For example, the NE 104 may be configured to obtain one or more QAM symbols, map the one or more QAM symbols to one or more sequence codes, map the one or more sequence codes to one or more codewords, and obtain data based at least in part on decoding the one or more codewords using FEC decoding. Each sequence code may be associated with coset representatives capable of representing a coset corresponding to a subset of QAM symbols of a QAM constellation.

In the context of wireless communications, a signal constellation can be regarded as a finite set of points taken from a larger, infinite lattice, and the partitioning of the constellation into subsets may correspond to partitioning the lattice into sublattices and their corresponding cosets. It has been found that some coded modulation schemes could be put into this framework. The codes in the modulation schemes may be more specifically characterized as lattice-type coset codes. Such general class of coded modulation schemes may be referred to as coset codes. The coset codes may provide a general approach to code construction for band-limited channels that approach channel capacity, similar to the function of conventional codes (both block and convolutional) for a power-limited case.

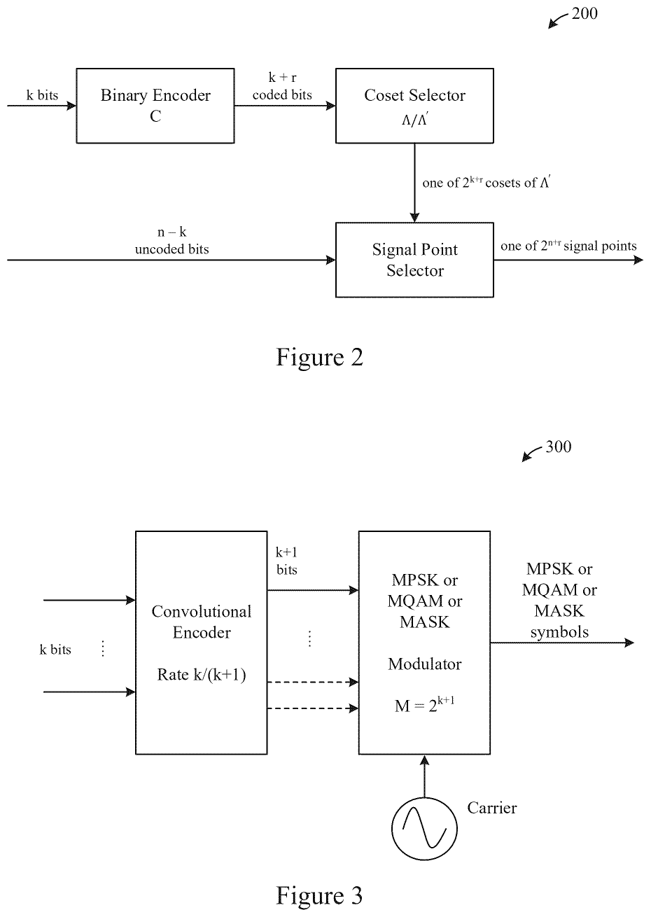

FIG. 2 illustrates an example of a coset code encoder 200 in accordance with aspects of the present disclosure.

The coset code encoder 200 may include an N-dimensional lattice Λ, which may be considered as an infinite regular array of points in an N-dimensional space. The signal points can all be taken from a finite subset of points lying within a translate or shift of Λ (i.e., coset), and the set of all possible signal points can be referred to as the signal constellation.

The coset code encoder 200 may also include a sublattice Λ′ of Λ, i.e., a subset of the points of Λ and which itself is an N-dimensional lattice. The sublattice Λ′ induces a partition Λ/Λ′ of Λ into |Λ/Λ′| cosets of Λ′, where |Λ/Λ′| is the order of the partition. When Λ and Λ′ are binary lattices, the order of the partition is a power of 2, say 2^{k+r}, and correspondingly, the partition divides the signal constellation into 2^{k+r} subsets, each corresponding to a distinct coset of Λ′.

The coset code encoder 200 may also include a rate k/(k+r) binary encoder C, which may receive k bits per N dimensions as input and may output k+r coded bits. The k+r coded bits may then select one of the cosets of Λ′ in the partition Λ/Λ′. The redundancy r(C) of C may be r bits per N dimensions. The normalized redundancy per two dimensions may be p(C)=2r(C)/N.

As shown in FIG. 2, data represented by n information bits are encoded per N dimensional symbol. The binary encoder C may receive k bits (of the n information bits) as input and output k+r coded bits. The coset selector may process the k+r coded bits to select one of 2^{k+r} cosets of sublattice Λ′ of the N-dimensional lattice Λ. The signal point selector may process n-k uncoded bits (i.e., the remaining information bits) and the selected coset to provide one of 2^{k+r} signal points.

Trellis coded modulation (TCM) generally combines modulation and encoding processes to achieve better efficiency without increasing bandwidth. Bandwidth-constrained channels may operate in the region R/W>1, where R is the data rate and W is the available bandwidth. For such channels, wireless communications systems may use bandwidth efficient multi-level phase modulation such as phase shift keying (PSK), phase amplitude modulation (PAM), or QAM.

FIG. 3 illustrates an example of Trellis coded modulation (TCM) 300 in accordance with aspects of the present disclosure. As shown in FIG. 3, a rate k/(k+1) convolutional encoder may process k bits to provide k+1 bits. A modulator (M-phase shift keying (MPSK), M-Quadrature Amplitude Modulation (MQAM), or M-array symbol keying (MASK), where M=2^{k+1}) may process the k+1 bits and a carrier signal to generate corresponding symbol(s) (MPSK, MQAM, or MASK symbol(s)).

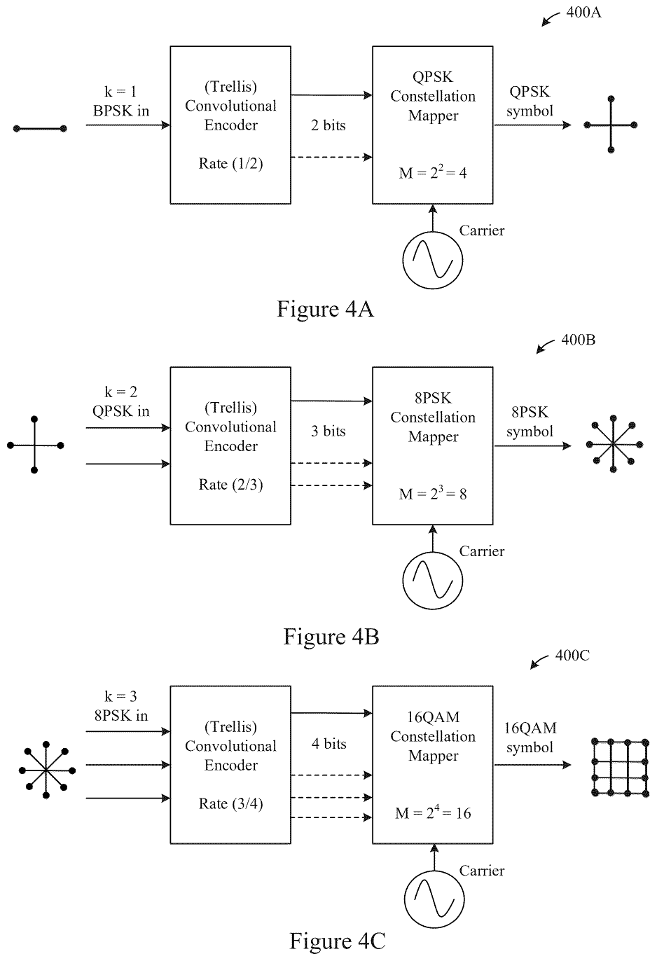

FIG. 4A illustrates an example of TCM 400A in accordance with aspects of the present disclosure. As shown in FIG. 4A, a rate 1/2 convolutional encoder may process 1 bit to provide 2 bits. A quadrature phase shift keying (4PSK) constellation mapper may process the 2 bits and a carrier signal to generate corresponding 4PSK symbol.

FIG. 4B illustrates an example of TCM 400B in accordance with aspects of the present disclosure. As shown in FIG. 4B, a rate 2/3 convolutional encoder may process 2 bits to provide 3 bits. A 8-phase shift keying (8PSK) constellation mapper may process the 3 bits and a carrier signal to generate corresponding 8-phase shift keying (8PSK) symbol.

FIG. 4C illustrates an example of TCM 400C in accordance with aspects of the present disclosure. As shown in FIG. 4C, a rate 3/4 convolutional encoder may process 3 bits to provide 4 bits. A 16QAM constellation mapper may process the 4 bits and a carrier signal to generate 16QAM symbol.

When TCM is applied to a bandwidth-constrained channel, a performance gain may be obtained without expanding the signal bandwidth. An increase in the number of signal phases from four to eight may require approximately 4 dB in additional signal power to maintain the same error rate. Hence, if TCM is to provide a benefit, the performance gain of the rate 2/3 code should overcome this 4 dB penalty. If the modulation is an integral part of the encoding process and is designed in conjunction with the code to increase the MSED between the pairs of coded signals, the loss from the expansion of the signal set may be overcome and significant coding gain may be achieved with relatively simple codes. Bandwidth-constrained system such as satellite modem system may benefit from this technique. The TCM Viterbi decoder may only support N=2 (only mother code rates of 1/2).

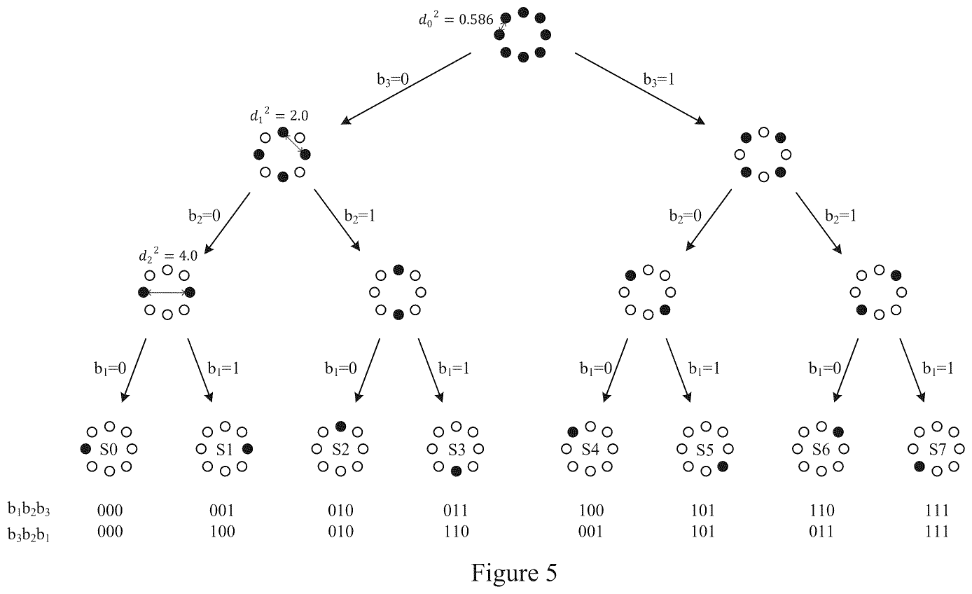

FIG. 5 illustrates an example of set partitioning of an 8PSK constellation in accordance with aspects of the present disclosure. As shown in FIG. 5, the 8-PSK constellation may be partitioned into disjoint cosets at each level and bits of the final sequence code are chosen at each level such that the MSED between sequences b₂b₃b₁ and b₁b₂b₃ may be maximized.

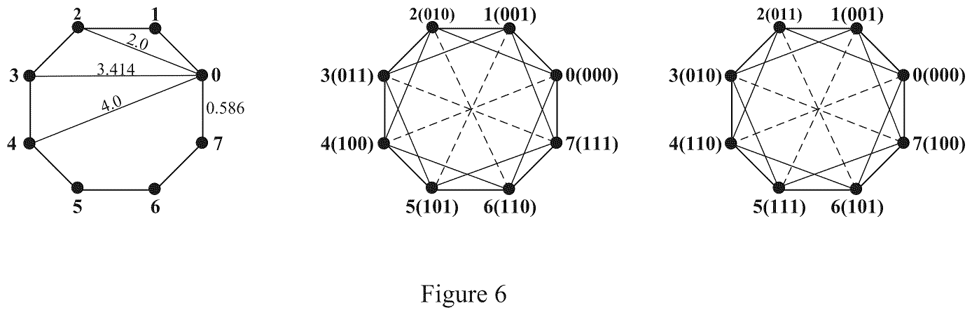

FIG. 6 illustrates examples of MSED of sequence coding in accordance with aspects of the present disclosure. The MSED between sequences may be different from the MSED between constellation symbols.

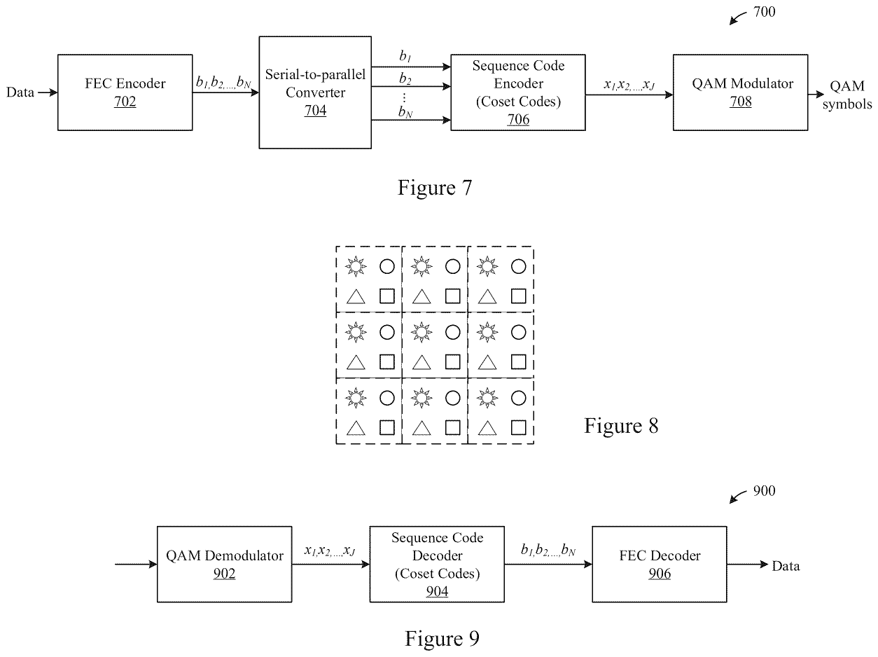

FIG. 7 illustrates an example of a transmitter chain 700 in accordance with aspects of the present disclosure. The transmitter chain 700 may include a FEC encoder 702 configured to encode data into codewords b₁,b₂, . . . , b_{N}, a serial-to-parallel converter 704 configured to convert the serially-concatenated codewords at the output of the FEC encoder 702 into multiple parallel codewords, a sequence code encoder 706 configured to map the codewords to sequence codes x₁,x₂, . . . ,xⱼ (where each sequence code being associated with coset representative(s) capable of representing that represents a coset corresponding to a subset of QAM symbols of a QAM constellation), and a QAM modulator 708 configured to map the sequence codes x₁,x₂, . . . , x_{J} to QAM symbols. In some implementations, the FEC encoder 702 may be a LDPC encoder.

In some implementations, the output of the FEC encoder 702 may be fed, optionally via the serial-to-parallel converter 704, into the sequence code encoder 706 (which can be considered as a bit-mapper) that is configured to map the FEC encoded bits to one or more symbols selected from coset representatives. In other words, the FEC encoded bits may be sequence coded using coset codes. In this case, each of the sequences may be selected from the same or from different cosets, where the QAM constellation symbols are partitioned into disjoint subsets using lattice partitioning techniques, and the M-ary QAM constellation is the union of different cosets (disjoint subsets) represented by coset representatives.

In some implementations, the mapping function could be defined as:

$$\begin{matrix}f : {\{ 0 , 1 \}}^{m} \to 𝒰 \\ {b}_{i} \to {x}_{l} = {G}_{{𝒞}_{j}} \cdot {b}_{i}\end{matrix}$$

where bᵢ is the i^{th} codeword (bits sequence) output by the FEC encoder 702, xₗ is the l^{th} (corresponding) sequence code (or coset representative(s)), [symbol] is a set of coset representatives which could be generated by the coset generator matrix [symbol] where [symbol] corresponds to the j^{th} coset.

In this case, the M-ary QAM constellation symbols/grid may be considered as a union of multiple cosets (such as that in FIG. 8, which shows a related example of a 64-QAM as a union of 4 disjoint cosets represented by different shapes) where:

$${𝒞}_{1} ⋃ {𝒞}_{2} ⋃ … {𝒞}_{J}$$

where J is the number of constellation cosets or partitions. The number of cosets may depend on the modulation order and/or the targeted sequence coding gain (which is a function of the MSED between the sequences (or sequence codes)).

In some implementations, the sequence coding using coset codes of the FEC encoded bits may be performed per codeword. In this case, the serial-to-parallel converter 704 may be operably coupled between the FEC encoder 702 and the sequence code encoder (which may also be referred to as coset code encoder) 706, and the codewords may be fed in parallel to the sequence code encoder 706.

In some implementations, the sequence code encoder 706 may map each codeword to a sequence code or coset representative(s) from the chosen cosets set [symbol] . The channel code rate may be preserved by the sequence code encoder 706. The sequence code block size may depend on the size of the cosets.

In wireless communications, it may be desirable to design codes in long sequences of messages. The allowed sequences should be very different from each other. The receiver may then choose a sequence from one or more sequences (or sequence codes) using their statistics and sequence distance metric rather than on symbol-by-symbol basis. When decoding in this way, the probability of error is an inverse function of the sequence length. In general form the probability of error Pₑ between sequences is given by the expression:

$${P}_{e} \approx {e}^{\frac{- {{d}_{min}}^{2}}{2 {σ}^{2}}}$$

where dₘᵢₙ² is the MSED between sequences and σ² is the noise power.

In some implementations, the gain of sequence coding applied by the transmitter chain 700 may compensate for reduced MSED imposed by high order modulation schemes, e.g., 1024-QAM, 4096-QAM, or beyond. In this case, the sequences of the symbols representing the mapping of the codewords to different coset representatives may be decoded at the receiver as sequence codes instead of on a symbol-by-symbol manner. In this case the minimum distance corresponds to the MSED between the received sequence and a reference sequence which is designed to be higher than the MSED between individual symbols.

In one example, two codewords of length n, b₁=(b_{1,1}, b_{1,2}, . . . , b_{1,n}) and b₂=(b_{2,1}, b_{2,2}, . . . , b_{2,n}), may be mapped to one or more symbols such that x₁=(s₀, s₁, s₂) and x₂=(s₃, s₄, s₅) such that the MSED between the sequences s₀s₁s₂ and s₃s₄s₅ is maximized. In this case, the sequences may be selected from different cosets [symbol] , [symbol] , . . . , [symbol] where the minimum squared Euclidean distance between the sequences is higher than the minimum distance between the constellation symbols. The minimum Euclidean distance d_{seq} between the sequences (or sequence codes) x₁ and x₂ may be determined based on the sum of the minimum Euclidean distances: d₀=s₀→s₃, d₁=s₁→s₄ and d₂=s₂→s₅ such that: d_{seq}=d₀+d₁+d₂.

It should be noted that the transmitter chain 700 described herein describes a possible implementation, and that the operations and the steps may be rearranged or otherwise modified and that other implementations are possible. For example, in some implementations, the serial-to-parallel converter 704 may be omitted and the sequence code encoder 706 may have information (e.g., block length) of the FEC encoder 702.

FIG. 9 illustrates an example of a receiver chain 900 in accordance with aspects of the present disclosure. The receiver chain 900 may include a QAM demodulator 902 configured to obtain QAM symbols (e.g., by detection/demodulation) and map the QAM symbols to sequence codes (where each sequence code is associated with multiple coset representatives that represent a coset corresponding to a subset of QAM symbols of a QAM constellation), a sequence code decoder 904 configured to map the sequence codes to codewords, and a FEC decoder 906 configured to decode the codewords to obtain data.

In some implementations, at the receiver chain 900, the received sequences may be decoded using the sequence code decoder 904 using an inverse function that maps the received sequence or coset representatives to a codeword. The output of the sequence code decoder 904 may then be fed to the FEC decoder 906 for decoding each of the codewords, e.g., using iterative decoding such as belief propagation or min sum algorithm.

In some implementations, the output of the sequence code decoder 904 may include extrinsic information such as likelihood ratios or log likelihood ratios that may then be fed to a FEC decoder 906 such as a soft-input decoder to decode and determine the received bits.

In some implementations, the mapping function (i.e., inverse mapping function) could be defined as:

$$\begin{matrix}f : 𝒰 \to {\{ 0 , 1 \}}^{m} \\ {x}_{l} \to {b}_{i} = {{G}_{{𝒞}_{j}}}^{- 1} \cdot {x}_{l}\end{matrix}$$

where xₗ is the l^{th} sequence code (or coset representatives), bᵢ is the i^{th} codeword, [symbol] is a set of coset representatives which could be generated by an inverse of the coset generator matrix [symbol] where [symbol] corresponds to the j^{th} coset.

Implementations described with reference to FIGS. 7 to 9 generally concern bits mapping to coset representatives.

In some implementations, sequences of symbols may be selected based on a set partitioning labeling procedure that maximizes the distance between the sequences or coset representatives. In this case, the M-ary QAM constellation may be considered as a lattice partition Λ/Λ′ and the coset representatives representing the sequence code may be chosen at each level of the set partitioning procedure, such that the minimum squared Euclidean distance is maximized when transiting from one level to another.

It should be noted that the receiver chain 900 described herein describes a possible implementation, and that the operations and the steps may be rearranged or otherwise modified and that other implementations are possible.

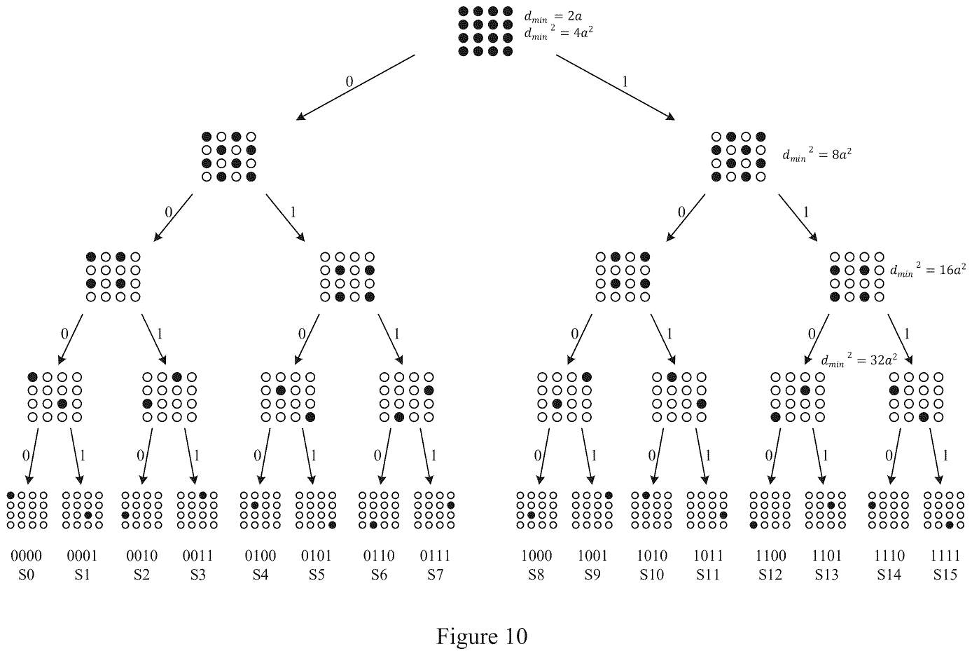

FIG. 10 illustrates an example of set partitioning of a 16-QAM constellation in accordance with aspects of the present disclosure. As shown in FIG. 10, the 16-QAM constellation may be partitioned into disjoint cosets at each level.

In some implementations, the set partitioning procedure and sequences selection may be performed by the network based on the selected modulation order M and signaled to the transmitter and/or receiver.

In some implementations, the set partitioning may be pre-configured and tabulated in a look-up table and selected based on the chosen code rate and modulation order (e.g. modulation coding scheme (MCS) index).

In some implementations, the set partitioning may be performed only for the cases of super-QAM (e.g., 1024-QAM or above) in which the sequence coding gain may be higher. In this case, the QAM modulations with low modulation order M may be considered as one coset where only channel coding gain and coherent detection schemes influence the overall performance.

Implementations described with reference to FIG. 10 generally concern set partitioning of QAM constellations.

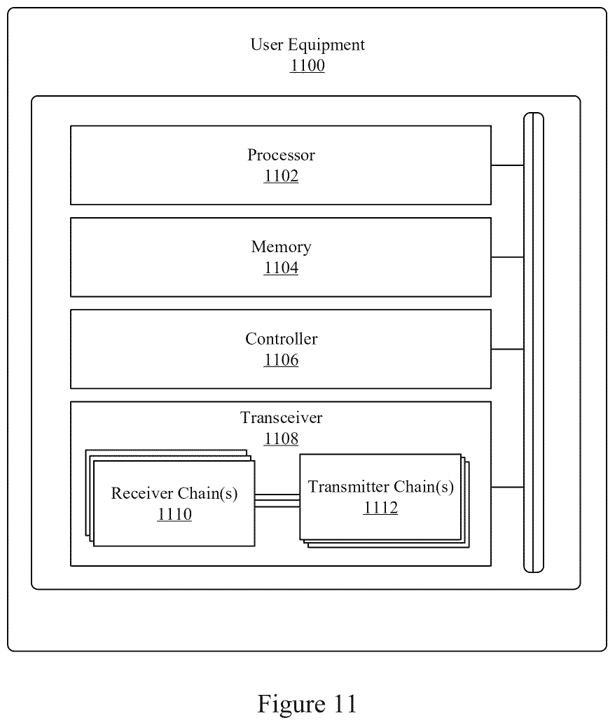

FIG. 11 illustrates an example of a UE 1100 in accordance with aspects of the present disclosure. The UE 1100 may be configured to support enhanced coded modulation for wireless communications. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communications at the UE 1100 in accordance with examples as disclosed herein.

In some implementations, the UE 1100 may be configured to support one or more means (e.g., the processor 1102) for: obtaining one or more codewords based at least in part on encoding data (e.g., information bits) using FEC encoding, mapping the one or more codewords to one or more sequence codes, mapping the one or more sequence codes to one or more QAM symbols, and obtaining the one or more QAM symbols. The mapping of the one or more codewords to the one or more sequence codes may be arranged such that each sequence code may be associated with multiple coset representatives capable of representing a coset corresponding to a subset of QAM symbols of a QAM constellation. For example, the QAM symbols of the QAM constellation may be partitioned into multiple disjoint subsets each corresponding to a respective coset representable by multiple coset representatives, and a quantity of disjoint subsets may be associated with at least one of a modulation order M of the QAM constellation or a sequence coding gain associated with the mapping of the one or more codewords to the one or more sequence codes. For example, the mapping of the one or more codewords to the one or more sequence codes may be based at least in part on a mapping function representable by bᵢ→xₗ= [symbol] , bᵢ, where bᵢ is the i^{th} codeword, xₗ is the l^{th} sequence code which comprises a bit sequence associated with corresponding coset representatives, and [symbol] is a coset generator matrix corresponding to the j^{th} coset [symbol] . For example, a MSED associated with any two sequence codes may be larger than a MSED associated with any two QAM symbols. For example, a modulation order M of the QAM constellation may be 2^{N} and N may be an integer greater than or equal to 10.

In some implementations, the UE 1100 may be configured to support one or more means (e.g., the processor 1102) for: performing a serial-to-parallel conversion to convert serially-concatenated codewords into multiple parallel codewords. For example, set partitioning of the QAM constellation may include the QAM constellation partitioned into multiple disjoint subsets each corresponding to a respective coset representable by coset representatives, and the partitioning may be such that a MSED is maximized or doubled for a transition from a higher partition level to a lower partition level, and the coset representatives may be selected at each of the partition levels. For example, the obtaining of the set partitioning of the QAM constellation may be based at least in part on: a modulation order M of the QAM constellation, a code rate, or both. For example, the obtaining of the set partitioning of the QAM constellation may be based at least in part on the modulation order M of the QAM constellation matching or exceeding a reference modulation order O (where O=2^{P}, and P may be an integer equal to 9).

In some implementations, the UE 1100 may be configured to support one or more means (e.g., the processor 1102) for: obtaining a set partitioning of the QAM constellation to facilitate mapping of the one or more codewords to the one or more sequence codes.

In some implementations, the UE 1100 may be configured to support one or more means (e.g., the processor 1102) for: obtaining one or more QAM symbols, mapping the one or more QAM symbols to one or more sequence codes, mapping the one or more sequence codes to one or more codewords, and obtaining data based at least in part on decoding the one or more codewords using FEC decoding. Each sequence code may be associated with multiple coset representatives capable of representing a coset corresponding to a subset of QAM symbols of an QAM constellation. For example, the mapping of the one or more sequence codes to the one or more codewords may be based at least in part on a mapping function representable by

$${x}_{l} \to {b}_{i} = {{G}_{{𝒞}_{j}}}^{- 1} \cdot {x}_{l}$$

where xₗ is the l^{th} sequence code which comprises a bit sequence associated with corresponding coset representatives, bᵢ is the i^{th} codeword, and

$${{G}_{{𝒞}_{j}}}^{- 1}$$

is an inverse of a coset generator matrix corresponding to the j^{th} coset [symbol] . For example, the modulation order M of the QAM constellation may be 2^{N}, where N may be an integer greater than or equal to 10.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receive the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the processing the demodulated signal to receive the transmitted data. In some implementations, the receiver chain 1110 may include a QAM demodulator configured to obtain one or more QAM symbols and map the one or more QAM symbols to one or more sequence codes, where each sequence code may be associated with coset representatives capable of representing a coset corresponding to a subset of QAM symbols of a QAM constellation. For example, the modulation order M of the QAM constellation may be 2^{N}, where N may be an integer greater than or equal to 10. In some implementations, the receiver chain 1110 may include a sequence code decoder configured to map the one or more sequence codes to one or more codewords. In some implementations, the receiver chain 1110 may include a FEC decoder configured to decode the one or more codewords to obtain (e.g., recover) data (e.g., information bits).

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium. In some implementations, the transmitter chain 1112 may include a FEC encoder configured to encode data (e.g., information bits) into one or more codewords. In some implementations, the transmitter chain 1112 may include a sequence code encoder configured to map the one or more codewords to one or more sequence codes, where the mapping is arranged such that each sequence code may be associated with multiple coset representatives capable of representing a coset corresponding to a subset of QAM symbols of a QAM constellation. In some implementations, the transmitter chain 1112 may include a QAM modulator (or mapper) configured to map the one or more sequence codes to one or more QAM symbols. In some implementations, the transmitter chain 1112 may include a serial-to-parallel converter operably coupled between the FEC encoder and the sequence code encoder. The serial-to-parallel converter may be configured to perform a serial-to-parallel conversion to convert serially-concatenated codewords into multiple parallel codewords.

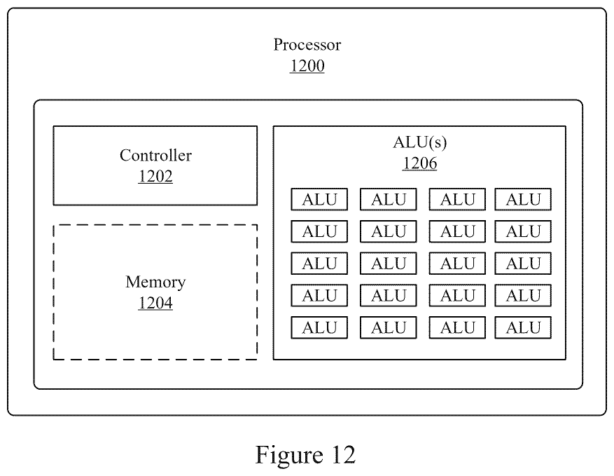

FIG. 12 illustrates an example of a processor 1200 in accordance with aspects of the present disclosure. The processor 1200 may be configured to support enhanced coded modulation for wireless communications. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, which may be, for example, an L1/L2/L3 cache. Additionally, or alternatively, the processor 1200 may optionally include one or more arithmetic-logic units (ALUs) 1206. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementations, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1206 may be configured to support various operations in accordance with examples as described herein. In some implementations, the one or more ALUs 1206 may reside within or on a processor chipset (e.g., the processor 1200). In some other implementations, the one or more ALUs 1206 may reside external to the processor chipset (e.g., the processor 1200). One or more ALUs 1206 may perform one or more computations such as addition, subtraction, multiplication, and division on data. For example, one or more ALUs 1206 may receive input operands and an operation code, which determines an operation to be executed. One or more ALUs 1206 be configured with a variety of logical and arithmetic circuits, including adders, subtractors, shifters, and logic gates, to process and manipulate the data according to the operation. Additionally, or alternatively, the one or more ALUs 1206 may support logical operations such as AND, OR, exclusive-OR (XOR), not-OR (NOR), and not-AND (NAND), enabling the one or more ALUs 1206 to handle conditional operations, comparisons, and bitwise operations.

The processor 1200 may support wireless communications in accordance with examples as disclosed herein. The processor 1200 may be configured to or operable to support one or more means for performing the operations described herein.

In some implementations, the processor 1200 may be configured to support one or more means for: obtaining one or more codewords based at least in part on encoding data (e.g., information bits) using FEC encoding, mapping the one or more codewords to one or more sequence codes, mapping the one or more sequence codes to one or more QAM symbols, and obtaining the one or more QAM symbols. The mapping of the one or more codewords to the one or more sequence codes may be arranged such that each sequence code may be associated with multiple coset representatives capable of representing a coset corresponding to a subset of QAM symbols of a QAM constellation. For example, the QAM symbols of the QAM constellation may be partitioned into multiple disjoint subsets each corresponding to a respective coset representable by multiple coset representatives, and a quantity of disjoint subsets may be associated with at least one of a modulation order M of the QAM constellation or a sequence coding gain associated with the mapping of the one or more codewords to the one or more sequence codes. For example, the mapping of the one or more codewords to the one or more sequence codes may be based at least in part on a mapping function representable by bᵢ→xₗ= [symbol] . bᵢ, where bᵢ is the i^{th} codeword, xₗ is the lₜₕ sequence code which comprises a bit sequence associated with corresponding coset representatives, and [symbol] is a coset generator matrix corresponding to the j^{th} coset [symbol] . For example, a MSED associated with any two sequence codes may be larger than a MSED associated with any two QAM symbols. For example, a modulation order M of the QAM constellation may be 2^{N} and N may be an integer greater than or equal to 10.

In some implementations, the processor 1200 may be configured to support one or more means for: performing a serial-to-parallel conversion to convert serially-concatenated codewords into multiple parallel codewords. For example, set partitioning of the QAM constellation may include the QAM constellation partitioned into multiple disjoint subsets each corresponding to a respective coset representable by coset representatives, and the partitioning may be such that a MSED is maximized or doubled for a transition from a higher partition level to a lower partition level, and the coset representatives may be selected at each of the partition levels. For example, the obtaining of the set partitioning of the QAM constellation may be based at least in part on: a modulation order M of the QAM constellation, a code rate, or both. For example, the obtaining of the set partitioning of the QAM constellation may be based at least in part on the modulation order M of the QAM constellation matching or exceeding a reference modulation order O (where O=2^{P}, and P may be an integer equal to 9).

In some implementations, the processor 1200 may be configured to support one or more means for: obtaining a set partitioning of the QAM constellation to facilitate mapping of the one or more codewords to the one or more sequence codes.

In some implementations, the processor 1200 may be configured to support one or more means for: obtaining one or more QAM symbols, mapping the one or more QAM symbols to one or more sequence codes, mapping the one or more sequence codes to one or more codewords, and obtaining data based at least in part on decoding the one or more codewords using FEC decoding. Each sequence code may be associated with multiple coset representatives capable of representing a coset corresponding to a subset of QAM symbols of an QAM constellation. For example, the mapping of the one or more sequence codes to the one or more codewords may be based at least in part on a mapping function representable by

$${x}_{l} \to {b}_{i} = {{G}_{{𝒞}_{j}}}^{- 1} \cdot {x}_{l} ,$$

where xₗ is the l^{th} sequence code which comprises a bit sequence associated with corresponding coset representatives, bᵢ is the i^{th} codeword, and

$${{G}_{{𝒞}_{j}}}^{- 1}$$

is an inverse of a coset generator matrix corresponding to the j^{th} coset [symbol] . For example, the modulation order M of the QAM constellation may be 2^{N}, where N may be an integer greater than or equal to 10.

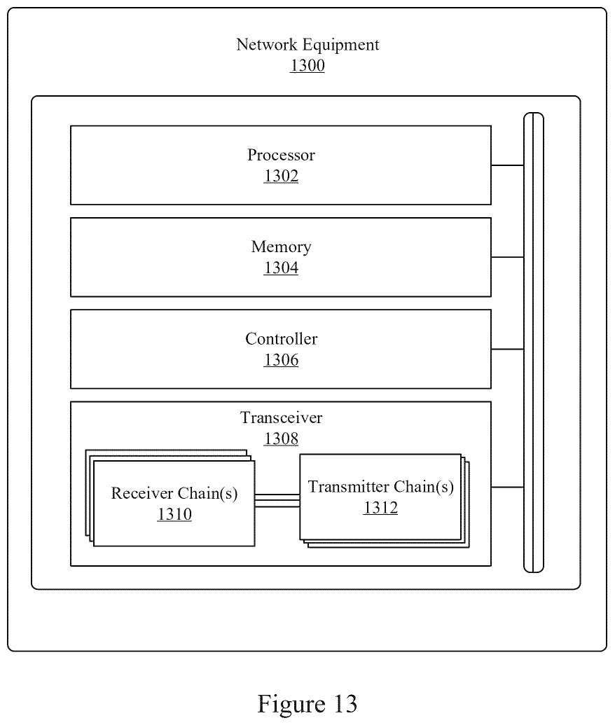

FIG. 13 illustrates an example of a NE 1300 in accordance with aspects of the present disclosure. The NE 1300 may be configured to support enhanced coded modulation for wireless communications. The NE 1300 may include a processor 1302, a memory 1304, a controller 1306, and a transceiver 1308. The processor 1302, the memory 1304, the controller 1306, or the transceiver 1308, or various combinations thereof or various components thereof may be examples of means for performing various aspects of the present disclosure as described herein. These components may be coupled (e.g., operatively, communicatively, functionally, electronically, electrically) via one or more interfaces.

The processor 1302, the memory 1304, the controller 1306, or the transceiver 1308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1302 may include an intelligent hardware device (e.g., a general-purpose processor, a DSP, a CPU, an ASIC, an FPGA, or any combination thereof). In some implementations, the processor 1302 may be configured to operate the memory 1304. In some other implementations, the memory 1304 may be integrated into the processor 1302. The processor 1302 may be configured to execute computer-readable instructions stored in the memory 1304 to cause the NE 1300 to perform various functions of the present disclosure.

The memory 1304 may include volatile or non-volatile memory. The memory 1304 may store computer-readable, computer-executable code including instructions when executed by the processor 1302 cause the NE 1300 to perform various functions described herein. The code may be stored in a non-transitory computer-readable medium such the memory 1304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1302 and the memory 1304 coupled with the processor 1302 may be configured to cause the NE 1300 to perform one or more of the functions described herein (e.g., executing, by the processor 1302, instructions stored in the memory 1304). For example, the processor 1302 may support wireless communications at the NE 1300 in accordance with examples as disclosed herein.

In some implementations, the NE 1300 may be configured to support one or more means (e.g., the processor 1302) for: obtaining one or more codewords based at least in part on encoding data (e.g., information bits) using FEC encoding, mapping the one or more codewords to one or more sequence codes, mapping the one or more sequence codes to one or more QAM symbols, and obtaining the one or more QAM symbols. The mapping of the one or more codewords to the one or more sequence codes may be arranged such that each sequence code may be associated with multiple coset representatives capable of representing a coset corresponding to a subset of QAM symbols of a QAM constellation. For example, the QAM symbols of the QAM constellation may be partitioned into multiple disjoint subsets each corresponding to a respective coset representable by multiple coset representatives, and a quantity of disjoint subsets may be associated with at least one of a modulation order M of the QAM constellation or a sequence coding gain associated with the mapping of the one or more codewords to the one or more sequence codes. For example, the mapping of the one or more codewords to the one or more sequence codes may be based at least in part on a mapping function representable by bᵢ→xₗ= [symbol] . bᵢ, where bᵢ is the i^{th} codeword, xₗ is the l^{th} sequence code which comprises a bit sequence associated with corresponding coset representatives, and [symbol] is a coset generator matrix corresponding to the j^{th} coset [symbol] . For example, a MSED associated with any two sequence codes may be larger than a MSED associated with any two QAM symbols. For example, a modulation order M of the QAM constellation may be 2^{N} and N may be an integer greater than or equal to 10.

In some implementations, the NE 1300 may be configured to support one or more means (e.g., the processor 1302) for: performing a serial-to-parallel conversion to convert serially-concatenated codewords into multiple parallel codewords. For example, set partitioning of the QAM constellation may include the QAM constellation partitioned into multiple disjoint subsets each corresponding to a respective coset representable by coset representatives, and the partitioning may be such that a MSED is maximized or doubled for a transition from a higher partition level to a lower partition level, and the coset representatives may be selected at each of the partition levels. For example, the obtaining of the set partitioning of the QAM constellation may be based at least in part on: a modulation order M of the QAM constellation, a code rate, or both. For example, the obtaining of the set partitioning of the QAM constellation may be based at least in part on the modulation order M of the QAM constellation matching or exceeding a reference modulation order O (where O=2^{P}, and P may be an integer equal to 9).

In some implementations, the NE 1300 may be configured to support one or more means (e.g., the processor 1302) for: obtaining a set partitioning of the QAM constellation to facilitate mapping of the one or more codewords to the one or more sequence codes.

In some implementations, the NE 1300 may be configured to support one or more means (e.g., the processor 1302) for: obtaining one or more QAM symbols, mapping the one or more QAM symbols to one or more sequence codes, mapping the one or more sequence codes to one or more codewords, and obtaining data based at least in part on decoding the one or more codewords using FEC decoding. Each of the one or more sequence codes may be associated with multiple coset representatives capable of representing a coset corresponding to a subset of QAM symbols of an QAM constellation. For example, the mapping of the one or more sequence codes to the one or more codewords may be based at least in part on a mapping function representable by

$${x}_{l} \to {b}_{i} = {{G}_{{𝒞}_{j}}}^{- 1} \cdot {x}_{l} ,$$

where xₗ is the l^{th} sequence code which comprises a bit sequence associated with corresponding coset representatives, bᵢ is the i^{th} codeword, and

$${{G}_{{𝒞}_{j}}}^{- 1}$$

is an inverse of a coset generator matrix corresponding to the j^{th} coset [symbol] . For example, the modulation order M of the QAM constellation may be 2^{N}, where N may be an integer greater than or equal to 10.

The controller 1306 may manage input and output signals for the NE 1300. The controller 1306 may also manage peripherals not integrated into the NE 1300. In some implementations, the controller 1306 may utilize an operating system such as iOS®, ANDROID®, WINDOWS®, or other operating systems. In some implementations, the controller 1306 may be implemented as part of the processor 1302.

In some implementations, the NE 1300 may include at least one transceiver 1308. In some other implementations, the NE 1300 may have more than one transceiver 1308. The transceiver 1308 may represent a wireless transceiver. The transceiver 1308 may include one or more receiver chains 1310, one or more transmitter chains 1312, or a combination thereof.

A receiver chain 1310 may be configured to receive signals (e.g., control information, data, packets) over a wireless medium. For example, the receiver chain 1310 may include one or more antennas for receive the signal over the air or wireless medium. The receiver chain 1310 may include at least one amplifier (e.g., a low-noise amplifier (LNA)) configured to amplify the received signal. The receiver chain 1310 may include at least one demodulator configured to demodulate the receive signal and obtain the transmitted data by reversing the modulation technique applied during transmission of the signal. The receiver chain 1310 may include at least one decoder for decoding the processing the demodulated signal to receive the transmitted data. In some implementations, the receiver chain 1310 may include a QAM demodulator configured to obtain one or more QAM symbols and map the one or more QAM symbols to one or more sequence codes, where each sequence code may be associated with coset representatives capable of representing a coset corresponding to a subset of QAM symbols of a QAM constellation. For example, the modulation order M of the QAM constellation may be 2^{N}, where N may be an integer greater than or equal to 10. In some implementations, the receiver chain 1310 may include a sequence code decoder configured to map the one or more sequence codes to one or more codewords. In some implementations, the receiver chain 1310 may include a FEC decoder configured to decode the one or more codewords to obtain (e.g., recover) data (e.g., information bits).

A transmitter chain 1312 may be configured to generate and transmit signals (e.g., control information, data, packets). The transmitter chain 1312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1312 may also include at least one power amplifier configured to amplify the modulated signal to an appropriate power level suitable for transmission over the wireless medium. The transmitter chain 1312 may also include one or more antennas for transmitting the amplified signal into the air or wireless medium. In some implementations, the transmitter chain 1312 may include a FEC encoder configured to encode data (e.g., information bits) into one or more codewords. In some implementations, the transmitter chain 1312 may include a sequence code encoder configured to map the one or more codewords to one or more sequence codes, where the mapping is arranged such that each sequence code may be associated with multiple coset representatives capable of representing a coset corresponding to a subset of QAM symbols of a QAM constellation. In some implementations, the transmitter chain 1312 may include a QAM modulator (or mapper) configured to map the one or more sequence codes to one or more QAM symbols. In some implementations, the transmitter chain 1312 may include a serial-to-parallel converter operably coupled between the FEC encoder and the sequence code encoder. The serial-to-parallel converter may be configured to perform a serial-to-parallel conversion to convert serially-concatenated codewords into multiple parallel codewords.

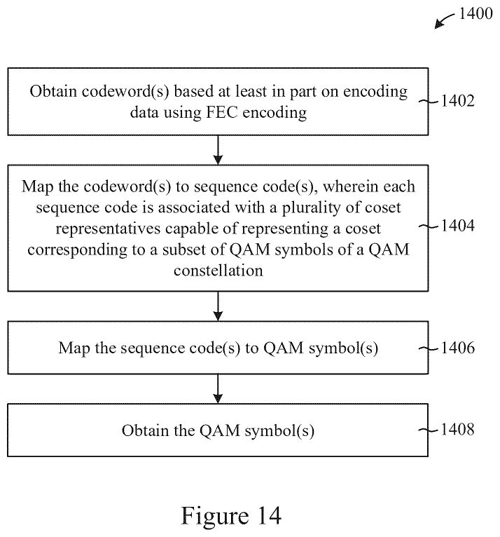

FIG. 14 illustrates a flowchart of a method 1400 in accordance with aspects of the present disclosure. In some implementations, the operations of the method 1400 may be implemented by a UE as described herein. In some implementations, the UE may execute a set of instructions to control the function elements of the UE to perform the described functions. In some implementations, the operations of the method 1400 may be implemented by a NE as described herein. In some implementations, the NE may execute a set of instructions to control the function elements of the NE to perform the described functions. In some implementations, the operations of the method 1400 may be implemented by a transmitter chain as described herein.

At 1402, the method 1400 may include obtaining one or more codewords based at least in part on encoding data (e.g., information bits) using FEC encoding. For example, the method 1400 may include obtaining one or more codewords based at least in part on encoding data (e.g., information bits) using LDPC encoding.

The operations of 1402 may be performed in accordance with examples as described herein. In some implementations, aspects of the operations of 1402 may be performed by a transmitter chain as described with reference to FIG. 7. In some implementations, aspects of the operations of 1402 may be performed by a UE as described with reference to FIG. 11. In some implementations, aspects of the operations of 1402 may be performed by a NE as described with reference to FIG. 13.

At 1404, the method 1400 may include mapping the one or more codewords to one or more sequence codes. The mapping may be arranged such that each of the one or more sequence codes may be associated with (e.g., formed by) multiple coset representatives capable of representing a coset corresponding to a subset of QAM symbols of a QAM constellation. In some implementations, the QAM symbols of the QAM constellation may be partitioned into multiple disjoint subsets each corresponding to a respective coset representable by coset representatives, and a quantity of disjoint subsets may be associated with at least one of a modulation order M of the QAM constellation or a sequence coding gain associated with the mapping of the one or more codewords to the one or more sequence codes. In some implementations, the mapping of the one or more codewords to the one or more sequence codes may be based on a mapping function. For example, the mapping function may be represented by bᵢ→xₗ= [symbol] . bᵢ, where bᵢ is the i^{th} codeword, xₗ is the l^{th} sequence code which comprises a bit sequence associated with corresponding coset representatives, and [symbol] is a coset generator matrix corresponding to the j^{th} coset [symbol] . In some implementations, the mapping of the one or more codewords to the one or more sequence codes may be based on a set partitioning of the QAM constellation. For example, the set partitioning of the QAM constellation may include the QAM constellation partitioned into multiple disjoint subsets each corresponding to a respective coset representable by coset representatives, and the partitioning may be such that a MSED is maximized (e.g., doubled) for a transition from a higher partition level to a lower partition level. For example, the coset representatives may be selected at each of the partition levels. In some implementations, a modulation order M of the QAM constellation may be 2^{N}, where N may be an integer greater than or equal to 10.

The operations of 1404 may be performed in accordance with examples as described herein. In some implementations, aspects of the operations of 1404 may be performed by a transmitter chain as described with reference to FIG. 7. In some implementations, aspects of the operations of 1404 may be performed by a UE as described with reference to FIG. 11. In some implementations, aspects of the operations of 1404 may be performed by a NE as described with reference to FIG. 13.

At 1406, the method 1400 may include mapping the one or more sequence codes to one or more QAM symbols. For example, the bits of the one or more sequence codes may be divided into multiple groups of N-bits based on the modulation order M (M=2^{N}) of the QAM constellation. Each bit group may then be mapped to a QAM symbol.

The operations of 1406 may be performed in accordance with examples as described herein. In some implementations, aspects of the operations of 1406 may be performed by a transmitter chain as described with reference to FIG. 7. In some implementations, aspects of the operations of 1406 may be performed by a UE as described with reference to FIG. 11. In some implementations, aspects of the operations of 1406 may be performed by a NE as described with reference to FIG. 13.

At 1408, the method 1400 may include obtaining the one or more QAM symbols.

The operations of 1408 may be performed in accordance with examples as described herein. In some implementations, aspects of the operations of 1408 may be performed by a transmitter chain as described with reference to FIG. 7. In some implementations, aspects of the operations of 1408 may be performed by a UE as described with reference to FIG. 11. In some implementations, aspects of the operations of 1408 may be performed by a NE as described with reference to FIG. 13.

It should be noted that the method 1400 described herein describes a possible implementation, and that the operations and the steps may be rearranged or otherwise modified and that other implementations are possible. For example, in some implementations, a MSED associated with any two sequence codes may be larger than a MSED between associated with two QAM symbols. For example, in some implementations, the method 1400 may include, at or before 1404, obtaining a set partitioning of the QAM constellation to facilitate the mapping of the one or more codewords to the one or more sequence codes. For example, the set partitioning may be obtained from the network. For example, the obtaining of the set partitioning of the QAM constellation may be based at least in part on a modulation order M of the QAM constellation, a code rate, or both. For example, the obtaining of the set partitioning of the QAM constellation may be based at least in part on the modulation order M of the QAM constellation matching or exceeding a reference modulation order O (where O=2^{P}, and P may be an integer equal to 9). For example, in some implementations, the one or more codewords may include serially-concatenated codewords and the method 1400 may include, between 1402 and 1404, perform a serial-to-parallel conversion to convert the serially-concatenated codewords into multiple parallel codewords.

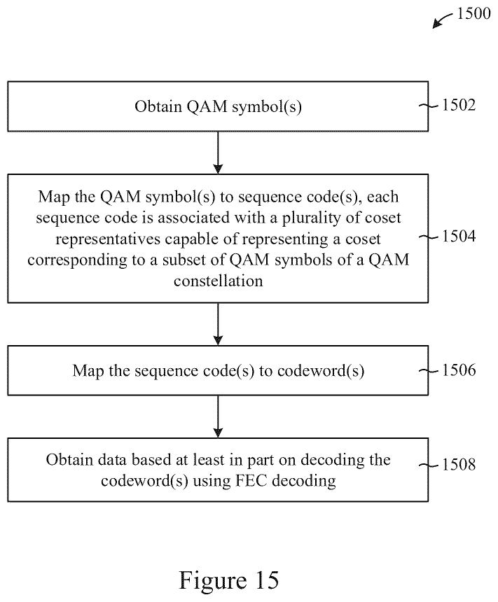

FIG. 15 illustrates a flowchart of a method 1500 in accordance with aspects of the present disclosure. In some implementations, the operations of the method 1500 may be implemented by a UE as described herein. In some implementations, the UE may execute a set of instructions to control the function elements of the UE to perform the described functions. In some implementations, the operations of the method 1500 may be implemented by a NE as described herein. In some implementations, the NE may execute a set of instructions to control the function elements of the NE to perform the described functions. In some implementations, the operations of the method 1500 may be implemented by a receiver chain for wireless communications as described herein.

At 1502, the method 1500 may include obtaining one or more QAM symbols. For example, obtaining the one or more QAM symbols may include detecting or demodulating the one or more QAM symbols.

The operations of 1502 may be performed in accordance with examples as described herein. In some implementations, aspects of the operations of 1502 may be performed by a receiver chain as described with reference to FIG. 9. In some implementations, aspects of the operations of 1502 may be performed by a UE as described with reference to FIG. 11. In some implementations, aspects of the operations of 1502 may be performed by a NE as described with reference to FIG. 13.

At 1504, the method 1500 may include mapping the one or more QAM symbols to one or more sequence codes. Each of the one or more sequence code may be associated with multiple coset representatives that is capable of representing a coset corresponding to a subset of QAM symbols of a QAM constellation. In some implementations, a modulation order M of the QAM constellation may be 2^{N}, where N may be an integer greater than or equal to 10.

The operations of 1504 may be performed in accordance with examples as described herein. In some implementations, aspects of the operations of 1504 may be performed by a receiver chain as described with reference to FIG. 9. In some implementations, aspects of the operations of 1504 may be performed by a UE as described with reference to FIG. 11. In some implementations, aspects of the operations of 1504 may be performed by a NE as described with reference to FIG. 13.

At 1506, the method 1500 may include mapping the one or more sequence codes to one or more codewords. In some implementations, the mapping of the one or more sequence codes to the one or more codewords may be based on a mapping function. For example, the mapping function may be represented by

$${x}_{l} \to {b}_{i} = {{G}_{{𝒞}_{j}}}^{- 1} \cdot {x}_{l} ,$$

where xₗ is the l^{th} sequence code which comprises a bit sequence associated with corresponding coset representatives, bᵢ is the i^{th} codeword, and

$${{G}_{{𝒞}_{j}}}^{- 1}$$

is an inverse of a coset generator matrix corresponding to the j^{th} coset [symbol] .

The operations of 1506 may be performed in accordance with examples as described herein. In some implementations, aspects of the operations of 1506 may be performed by a receiver chain as described with reference to FIG. 9. In some implementations, aspects of the operations of 1506 may be performed by a UE as described with reference to FIG. 11. In some implementations, aspects of the operations of 1506 may be performed by a NE as described with reference to FIG. 13.

At 1508, the method 1500 may include obtaining data (e.g., information bits) based at least in part on decoding the one or more codewords using FEC decoding. For example, the method 1500 may include obtaining data (e.g., information bits) based at least in part on decoding the one or more codewords using LDPC decoding.

The operations of 1508 may be performed in accordance with examples as described herein. In some implementations, aspects of the operations of 1508 may be performed by a receiver chain as described with reference to FIG. 9. In some implementations, aspects of the operations of 1508 may be performed by a UE as described with reference to FIG. 11. In some implementations, aspects of the operations of 1508 may be performed by a NE as described with reference to FIG. 13.

It should be noted that the method 1500 described herein describes a possible implementation, and that the operations and the steps may be rearranged or otherwise modified and that other implementations are possible.

Some implementations of the methods, systems, and apparatuses described herein may include, at the transmitting end, (i) encoding a sequence of bits to generate a sequence of encoded bits, e.g., using a FEC encoder, (ii) converting the sequences of encoded bits from serially concatenated codewords to parallel streams of encoded bits (codewords), e.g., using a serial-to-parallel converter, (iii) applying the parallel streams of encoded bits to a sequence code encoder that is configured to map the codewords to sequences selected from a set of coset representatives, and (iv) mapping the sequences to QAM-symbols selected from a QAM modulation scheme, e.g., using a QAM modulator/mapper. The different sequences of the sequence code encoder may be associated with (e.g., selected from) similar or different cosets. The sequence coding gain may compensate for a reduced MSED of the QAM modulation scheme. The MSED between the sequences of the sequence code encoder may be arranged such that the MSED between sequences is larger than the MSED between constellation symbols of the QAM modulation scheme. At the receiving end, the receiver may correspondingly receive a signal, perform QAM symbol detection based on the received signal, perform sequence code decoding, and perform forward error correction decoding. The sequence code decoding may be performed by applying an inverse mapping function (i.e., an inverse of the mapping function) used by the sequence code encoder. The output of the sequence code decoder may be hard decisions on sequences bits or alternatively extrinsic information that might include likelihood ratios or log likelihood ratios.

Some implementations of the methods, systems, and apparatuses described herein may include, (i) partitioning a QAM constellation (e.g., a super QAM with a modulation order of at least 10) into disjoint subsets known as cosets (the partitioning may be performed such as at each partition level, the minimum squared Euclidean distance is doubled or maximized), (ii) selecting coset representatives at each partition level, (iii) mapping encoded bits to one or more coset representatives selected from one or more cosets or sets partitions. The set partitioning parameters may be configured by the network based on the modulation order of the a QAM constellation and a code rate.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
at least one memory; and
at least one processor coupled with the at least one memory and operable to cause the apparatus to:
obtain one or more codewords based at least in part on encoding data using forward error correction (FEC) encoding;
map the one or more codewords to one or more sequence codes, wherein each sequence code of the one or more sequence codes is associated with a plurality of coset representatives capable of representing a coset corresponding to a subset of quadrature amplitude modulation (QAM) symbols of a QAM constellation;
map the one or more sequence codes to one or more QAM symbols; and
obtain the one or more QAM symbols.

2. The apparatus of claim 1, wherein the mapping of the one or more codewords to one or more sequence codes is based at least in part on the QAM symbols of the QAM constellation partitioned into a plurality of disjoint subsets each corresponding to a respective coset representable by coset representatives, and a quantity of disjoint subsets is associated with at least one of a modulation order M of the QAM constellation or a sequence coding gain associated with the mapping of the one or more codewords to the one or more sequence codes.

3. The apparatus of claim 1, wherein:
the one or more codewords comprise serially-concatenated codewords; and
the at least one processor is operable to cause the apparatus to perform a serial-to-parallel conversion to convert the serially-concatenated codewords into a plurality of parallel codewords, prior to mapping the one or more codewords to one or more sequence codes.

4. The apparatus of claim 1, wherein the at least one processor is operable to cause the apparatus to map the one or more codewords to the one or more sequence codes based at least in part on a mapping function representable by:
$${b}_{i} \to {x}_{l} = {G}_{{𝒞}_{j}} \cdot {b}_{i}$$
where bᵢ is the i^{th} codeword, xᵢ is the l^{th} sequence code which comprises a bit sequence associated with corresponding coset representatives, and [symbol] is a coset generator matrix corresponding to the j^{th} coset [symbol] .

5. The apparatus of claim 1, wherein a minimum squared Euclidean distance (MSED) associated with any two sequence codes is larger than a MSED associated with any two QAM symbols.

6. The apparatus of claim 1, wherein the at least one processor is operable to cause the apparatus to:
obtain a set partitioning of the QAM constellation; and
map the one or more codewords to the one or more sequence codes based at least in part on the set partitioning of the QAM constellation.

7. The apparatus of claim 6, wherein:
the set partitioning of the QAM constellation comprises the QAM constellation partitioned into a plurality of disjoint subsets each corresponding to a respective coset representable by a plurality of coset representatives, and the partitioning is such that a MSED is maximized for a transition from a higher partition level to a lower partition level; and
the coset representatives are selected at each of the partition levels.

8. The apparatus of claim 6, wherein the obtaining of the set partitioning of the QAM constellation is based at least in part on: a modulation order M of the QAM constellation, a code rate, or both.

9. The apparatus of claim 6, wherein the obtaining of the set partitioning of the QAM constellation is based at least in part on a modulation order M of the QAM constellation matching or exceeding a reference modulation order.

10. The apparatus of claim 1, wherein a modulation order M of the QAM constellation is 2^{N}, where N is an integer greater than or equal to 10.

11. The apparatus of claim 1, wherein the apparatus is a user equipment (UE).

12. The apparatus of claim 1, wherein the apparatus is a network equipment (NE).

13. An apparatus for wireless communications, comprising:
at least one memory; and
at least one processor coupled with the at least one memory and operable to cause the apparatus to:
obtain one or more quadrature amplitude modulation (QAM) symbols;
map the one or more QAM symbols to one or more sequence codes, wherein each sequence code of the one or more sequence codes is associated with a plurality of coset representatives capable of representing a coset corresponding to a subset of QAM symbols of a QAM constellation;
map the one or more sequence codes to one or more codewords; and
obtain data based at least in part on decoding the one or more codewords using forward error correction (FEC) decoding.

14. The apparatus of claim 13, wherein the at least one processor is operable to cause the apparatus to map the one or more sequence codes to the one or more codewords based at least in part on a mapping function representable by:
$${x}_{l} \to {b}_{i} = {{G}_{{𝒞}_{j}}}^{- 1} \cdot {x}_{l}$$
where xₗ is the l^{th} sequence code which comprises a bit sequence associated with corresponding coset representatives, bᵢ is the i^{th} codeword, and
$${{G}_{{𝒞}_{j}}}^{- 1}$$
is an inverse of a coset generator matrix corresponding to the j^{th} coset [symbol] .

15. The apparatus of claim 13, wherein a modulation order M of the QAM constellation is 2^{N}, where N is an integer greater than or equal to 10.

16. The apparatus of claim 13, wherein the apparatus is a user equipment (UE).

17. The apparatus of claim 13, wherein the apparatus is a network equipment (NE).

18. A transmitter chain for wireless communications, comprising:
a forward error correction (FEC) encoder configured to encode data into one or more codewords;
a sequence code encoder configured to map the one or more codewords to one or more sequence codes such that each sequence code of the one or more sequence codes is associated with a plurality of coset representatives capable of representing a coset corresponding to a subset of quadrature amplitude modulation (QAM) symbols of a QAM constellation; and
a QAM modulator configured to map the one or more sequence codes to one or more QAM symbols.

19. The transmitter chain of claim 18, wherein:
the one or more codewords comprise serially-concatenated codewords; and
the transmitter chain further comprises:
a serial-to-parallel converter operably coupled between the FEC encoder and the sequence code encoder, the serial-to-parallel converter is configured to perform a serial-to-parallel conversion to convert the serially-concatenated codewords into a plurality of parallel codewords.

20. A receiver chain for wireless communications, comprising:
a quadrature amplitude modulation (QAM) demodulator configured to obtain one or more QAM symbols and map the one or more QAM symbols to one or more sequence codes, wherein each sequence code of the one or more sequence codes is associated with a plurality of coset representatives capable of representing a coset corresponding to a subset of QAM symbols of a QAM constellation;
a sequence code decoder configured to map the one or more sequence codes to one or more codewords; and
a forward error correction (FEC) decoder configured to decode the one or more codewords to obtain data.
